(19) United States
(12) Patent Application Publication
(10) Pub. No.: US 2021/0288334 A1
(43) Pub. Date: Sep. 16, 2021

(54) A BIMETALLIC CATALYST AND FUEL FOR USE IN A DIRECT DIMETHYL ETHER FUEL CELL

(71) Applicant: BAR ILAN UNIVERSITY, Ramat Gan (IL)

(72) Inventors: Lior ELBAZ ALON, Tzoran (IL); Ronit SHARABI, Kfar Yona (IL); Bar GAVRIEL, Lod (IL)

(73) Assignee: BAR ILAN UNIVERSITY, Ramat Gan (IL)

(21) Appl. No.: 16/332,557

(22) PCT Filed: Sep. 12, 2017
(86) PCT No.: PCT/IL2017/051027

§ 371 Date: Mar. 12, 2019

(30) Foreign Application Priority Data
Sep. 12, 2016 (IL) 247784

(51) Int. Cl. H01M 4/92; H01M 8/1004; H01M 8/1009; C22C 5/04

(52) U.S. Cl. CPC H01M 4/921; H01M 8/1004; H01M 2004/8684; H01M 4/925; C22C 5/04; H01M 8/1009

(57) ABSTRACT

A bimetallic catalyst alloy is provided for use in fuel cells, particularly in the oxidation of dimethyl ether in a direct dimethyl ether fuel cell.

### TECHNOLOGICAL FIELD

The present disclosure generally relates to bimetallic catalysts, uses thereof and fuel for use in a direct dimethyl ether fuel cell.

### BACKGROUND

A fuel cell typically includes an anode (negative electrode), cathode (positive electrode) and a membrane, typically a proton conducting membrane, formed of a polymer electrolyte, is disposed between both electrodes. Each of the anode and cathode typically include a gas diffusion electrode comprising a support layer for supplying reactants, a catalytic layer and a current collector. The reactants are subjected to redox reactions.

In a direct dimethyl ether fuel cell (“DDMEFC”), oxidation of dimethyl ether (“DME”) occurs at an anode, and the protons and electrons produced by the oxidation are transferred to a cathode. The protons transferred to the cathode are bonded to oxygen to form water and the electromotive force generated by such reduction of oxygen becomes an energy source for the fuel cell. Such reactions that occur at an anode and a cathode of a DDMEFC are represented by the following reaction formulae:

$$\begin{matrix}Anode \text{:} {CH}_{3} {OCH}_{3} + 3 {H}_{2} O \to 2 {CO}_{2} + 12 {H}^{+} + 12 {e}^{-} {E}_{a} = 0.05 V & ( 1 ) \\ Cathode \text{:} 3 {O}_{2} + 12 {H}^{+} + 12 {e}^{-} \to 6 {H}_{2} O {E}_{c} = 1.23 V & ( 2 ) \\ Total : {CH}_{3} {OCH}_{3} + 3 {O}_{2} \to 2 {CO}_{2} + 3 {H}_{2} O {E}_{cell} = 1.18 V & ( 3 )\end{matrix}$$

In the above reaction formulae, reduction of oxygen at the cathode and oxidation of DME at the anode significantly affect the quality of a fuel cell. Typically, platinum is used as an anode catalyst for facilitating DME electrooxidation reaction, and for oxygen electroreduction at the cathode. DME used as fuel for anodic oxidation, may cause DME crossover, in which DME crosses over to the cathode side from an anode through a polymer electrolyte, thereby functioning as catalytic poison for the cathode material, resulting in significant degradation in catalytic availability and overall quality of the fuel cell. Because of the above-mentioned reasons, there is an additional deficiency in that the concentration of DME as material for anodic oxidation is limited.

To date, the mechanism of DME oxidation has not been fully clarified. A possible mechanism of DME oxidation on Pt was proposed by Müller et al. [1]. Several DME adsorption species, such as (CH₃OC—)_{ad}, CO_{L} (linearly bonded CO), and CO_{B}(bridge-bonded CO), were detected. The oxidation of CO_{ads} is most likely the rate-determining step (RDS) of DME oxidation at low potentials [2]. Similar to methanol oxidation, bimetallic platinum-based alloys capable of mitigating the poisonous effect of CO_{ads} on Pt were found to be the most effective in DME oxidation. Liu et al. [3] investigated the DME oxidation on a series of PtM/C (M=Ru, Sn, Mo, Cr, Ni, Co, W) and Pt/C electrocatalysts and demonstrated that PtRu/C shows the best electrocatalytic activity and the highest tolerance to the chemisorbed poisonous species at low potentials, specifically, in the low over-potential range (i.e., below 0.55V, 50° C.), however, at the higher potential (i.e., above 0.55V, 50° C.), the NC displayed better activity than PtRu/C.

As known in the field, a catalyst is utilized in a fuel cell to allow a molecule or a radical to be adsorbed on a surface of the catalyst, thereby accelerating an electrochemical reaction. Precious metals, in particular platinum, are known for promoting DME oxidation reaction at the anode side in a DME fuel cell. One of the drawbacks associated with such precious metal catalysts in oxidizing DME in a direct dimethyl ether fuel cell, is that an intermediate product, such as carbon monoxide, causes a reduction in catalytic activity (also known as catalyst poisoning), and therefore fuel cell performance is deteriorated over time during operation. Such deficiencies occur in catalysts comprising platinum-containing alloys as well as for pure platinum. An additional drawback of using platinum catalyst is that it is an expensive material, and when poisoned, its activity deteriorates and the expensive catalyst is wasted.

US Patent Application no. 2005142433 [4] provides a fuel cell for generating electricity using a fuel and an oxidant comprising: a hydrogen ion conductive polymer electrolyte membrane; an anode including an anode catalyst layer located on one surface of the polymer electrolyte membrane, and an anode diffusion layer located on the outer surface of the anode catalyst layer; and a cathode including a cathode catalyst layer located on the other surface of the polymer electrolyte membrane, and a cathode diffusion layer located on the outer surface of the cathode catalyst layer, wherein the anode catalyst layer includes conductive carbon particles supporting a platinum catalyst thereon and a hydrogen ion conductive polymer electrolyte, and at least either of (1) a discontinuous catalyst layer being formed on a surface of the anode catalyst layer and having a higher density of platinum-type catalyst than the anode catalyst layer and (2) an electrolyte polymer layer is formed at the interface between the anode catalyst layer and the polymer electrolyte membrane.

Japanese Patent Application no. JP8203537 [5] provides a first layer for mainly oxidizing hydrogen made of platinum holding catalyst, and a catalyst layer consisting of a second layer for oxidizing mainly CO, comprising a multi-element system catalyst consisting of at least one or more kinds of element selected from among elements Lu, Sn, Os, Rh, Pd, Ni, Cu, Co, Mn, Zn, Ir, Fe and element Pt. As a result, CO included in the fuel gas supplied form the diffusion layer side is alternatively oxidized in CO₂.

US Patent Application no. US2016197358 [6] describes a catalyst alloy particle(s) formed of platinum atom and a non-platinum metal atom, wherein (i) the alloy particle has an L1₂ structure as an internal structure and has an extent of ordering of L1₂ structure in the range of 30 to 100 percent, (ii) the alloy particle has an LP ratio calculated by CO stripping method of 10 percent or more, and (iii) the alloy particle has a dN/dA ratio in the range of 0.4 to 1.0.

### REFERENCES

[1] J. T. Muller, P. M. Urban, W. F. Holderich, K. M. Colbow, J. Zhang, D. P. Wilkinson, J Electrochem Soc 147, 4058 (2000).
[2] Li Q., Wu, G. Johnston, C. M. et al., Electrocatalysis (2014) 5: 310, doi:10.1007/s12678-014-0196-z.
[3] Y. Liu, S. Mitsushima, K. Ota, N. Kamiya, Electrochim Acta, 51, 6503 (2006).
[4] US2005142433.
[5] JP8203537.
[6] US2016197358.

### SUMMARY OF THE INVENTION

Among the deficiencies encountered in using fuel cells of the art, fuel crossover seems to be one of the less desired ones. Fuel crossover is an undesired permeation of fuel molecules through the electrolyte membrane to the cathode chamber, causing lowering of the operating potential between the anode and the cathode in the fuel cell. The rate of crossover is proportional to the permeability of the fuel through the electrolyte membrane and depends on the fuel concentration and temperature. The objective of the present invention is to provide a bimetallic catalyst for effective electro-oxidation of dimethyl ether (“DME”) at the anode of a direct dimethyl ether fuel cell (“DDMEFC”) that is capable of operating at moderate temperatures and voltages, that is durable and cost-effective. The catalytic material of the invention is utilized as a tool for improving the efficiency of DME fuel cells and management of fuel crossover.

The family of bimetallic Pt-based catalysts of the invention enable prolonged operation of DME fuel cells at moderate temperatures and are tolerant to impurities (i.e., chemisorbed bi-products such as CO_{ads}) that may be present in the fuel. It is therefore an objective of the invention to provide a family of bimetallic catalyst for use in oxidizing dimethyl ether (DME) in a direct dimethyl ether fuel cell (DDMEFC), in particular, the bimetallic catalysts comprising each a platinum atom and a first row transition metal as defined herein (e.g., an element selected from copper, nickel, cobalt, manganese, chromium, titanium, etc). The catalysts of the invention are cost-effective and exhibit improved and increased fuel cell activity and efficiency, specifically, low cell resistance and high power density.

Further objectives are to provide an anode, a membrane electrode assembly (MEA) and a fuel cell, e.g., a DDMEFC, comprising or utilizing the bimetallic catalyst disclosed herein, supported on a carrier such as a conductive carrier.

The invention further provides a fuel formulation comprising a mixture of water and dimethyl ether, for supply to the anode of a dimethyl ether fuel cell that results in improved kinetics of DME oxidation. In some embodiments, the fuel formulation having a DME molar concentration in water of 1.1M at 20° C., as measured with H¹ NMR at 20° C. while bubbling DME in water for 15 min (dimethyl ether has a solubility in water at 20° C. of 71 g/dm⁻³, namely, 1.1M-1.54M).

Further, the present invention provides means for operating a DDMEFC in an efficient and cost-effective manner, in particular, means for providing fuel to the DDMEFC, DME flow rate, anode back pressure, and membrane thickness; to thereby improve DME oxidation and reduce fuel crossover, thereby minimizing loss of DME oxidation activity.

The bimetallic catalyst, herein “catalyst”, in accordance with the present invention is a dimethyl ether oxidation reaction (termed “DOR”) catalyst used for accelerating DOR at the anode, and consists of two elements: (i) platinum and (ii) a transition metal selected from copper, nickel, cobalt, manganese, chromium and titanium, or any mixture thereof; at a molar ratio between 1:4 to 2:1. In some embodiments, the transition metal is selected from copper, nickel and chromium. In some embodiments, the transition metal is selected from copper and nickel. In some embodiments, the transition metal is copper.

In some embodiments, the transition metal is any one of copper, nickel, cobalt, manganese, chromium or titanium.

In some embodiments, the bimetallic catalyst consists essentially of (i) platinum and (ii) a transition metal selected from copper, nickel, cobalt, manganese, chromium and titanium.

In some embodiments, the bimetallic catalyst consists of platinum and copper.

The bimetallic catalyst of the invention may be in the form of nanoparticles, namely, in the form of a particulate material having at least one dimension at the nano-scale (i.e., having a mean particle size below 1000 nm). In some embodiments, the bimetallic catalyst comprises particles having mean particle size between about 1 nm and 50 nm. In other embodiments, the bimetallic catalyst comprises particles having mean particle size between about 1 nm and 20 nm. In some embodiments, the bimetallic catalyst comprises particles having mean particle size between about 1 nm and 10 nm. In other embodiments, the bimetallic catalyst comprises particles having mean particle size between about 3 nm and 8 nm.

Thus, the present invention provides a bimetallic catalyst of the structure PtM, wherein Pt is platinum and M is a transition metal selected from copper, nickel, cobalt, manganese, chromium and titanium; wherein the molar ratio of the platinum to the transition metal (Pt:M) is between about 1:4 to 2:1 (namely, 1:4 to 8:4), the catalyst being for use in oxidation of dimethyl ether in a direct dimethyl ether fuel cell.

In some embodiments, the molar ratio of the platinum to the transition metal is between about 1:1 to 2:1.

In other embodiments, the molar ratio of the platinum to the transition metal is between about 4:3 to 6:3.

In some other embodiments, the molar ratio of the platinum to the transition metal is about 3:3 or 4:3 or 6:3.

In some embodiments, the molar ratio is not 3:2.

In some embodiments, the bimetallic catalyst is an alloy of platinum and the transition metal, as selected. As disclosed herein, the catalyst is a mixture of the two atoms formed into a single composition of the two atoms, the composition (alloy) being of a defined, selected, form (crystallographic structure) and consisting the atoms in a desired molar ratio (or atomic composition). While the alloy may contain minute amounts of impurities (the impurities being of at least one other metal or of a non-metal material), these impurities are of no effect and contribute nothing to the operation and efficiency of the fuel cell. The impurities may be derived from the material precursors used in the preparation of the catalysts or from any other material (e.g., solvents, solid carrier, etc) used in the preparation process. The impurities may be in the ppm levels or up to 0.5-1 wt % of the total weight of the catalyst.

As noted above, one of the properties that results in a bimetallic catalyst having high activity for DOR is the structure of the catalyst. The PtM surface, wherein M is a transition metal of the kind described herein, at a molar ratio defined herein, has a higher DME oxidation activity than PtM at a ratio of 3:2 Pt:M (See FIG. 5B). Without wishing to be bound by theory, the inventors attribute this dramatic increase in performance to modifications in the electronic structure of the surface, reducing its tendency to bond or associate to impurities present in the fuel cells and an increase in the number of available sites for DME adsorption and oxidation. Thus, in some embodiments, the invention provides a bimetallic catalyst PtM; wherein the molar ratio Pt:M is between about 1:4 to 2:1, or is between about 1:1 to 2:1, or is between about 4:3 to 6:3 or is about 3:3 or 4:3 or 6:3.

In some embodiments, M is copper. In some embodiments, the Pt:Cu molar ratio is between about 1:4 to 2:1, or is between about 1:1 to 2:1, or is between about 4:3 to 6:3 or is about 3:3 or 4:3 or 6:3.

In another of its aspects, the present disclosure provides a bimetallic catalyst comprising:

(a) platinum; and

(b) a transition metal selected from copper, nickel, cobalt, manganese, chromium and titanium;

wherein the platinum is at a concentration of less than about 70 atomic percent, said catalyst being for use in a direct dimethyl ether fuel cell.

In some embodiments, the platinum concentration in the bimetallic catalyst is less than about 65 atomic percent, at times less than about 60 atomic percent, less than about 55 atomic percent, less than 50 atomic percent, less than 45 atomic percent, and further less than about 40 atomic percent.

In some embodiments, the platinum concentration in the bimetallic catalyst is between about 20 to 80 atomic percent, at times between about 45 to 75 atomic percent, at times between about 50 to 70 atomic percent, at times between about 55 to 70 atomic percent, at times between about 56 to 67 atomic percent, at times between about 57 to 66 atomic percent.

In some embodiments, the platinum concentration in the bimetallic catalyst described herein is selected from 50 atomic percent, 55 atomic percent, 57 atomic percent, 59 atomic percent, 60 atomic percent, 62 atomic percent, 64 atomic percent, 66 atomic percent, 67 atomic percent, 68 atomic percent, 70 atomic percent.

In some embodiments, the transition metal (M) concentration is between about 30 to 80 atomic percent, at times between about 30 to 70 atomic percent, at times between about 30 to 60 atomic percent, at times between about 30 to 50 atomic percent, at times between about 33 to 50 atomic percent, at times between about 33 to 45 atomic percent, at times between about 40 to 50 atomic percent.

In some embodiments, the transition metal concentration is more than about 30 atomic percent, at times more than about 33 atomic percent, more than about 35 atomic percent, more than about 40 atomic percent, more than about 45 atomic percent, and further at times more than about 50 atomic percent.

The bimetallic catalyst of the invention is further distinguishable from inferior catalysts of the art in its X-ray diffraction (XRD) pattern. The bimetallic catalyst comprises alloy particles having fm-3m structure (analyzed by X-ray diffraction).

In some embodiments, the bimetallic catalyst has a crystallographic structure L1₀ (as known in the art: Structure of Materials: An Introduction to Crystallography, Diffraction and Symmetry, De Graef and McHenry).

In some embodiments, the bimetallic catalyst has a crystallographic structure different from L1₂ (as known in the art: Structure of Materials: An Introduction to Crystallography, Diffraction and Symmetry, De Graef and McHenry).

The bimetallic catalyst may be alternatively or additionally characterized by having an XRD spectrum lacking (not having, being free of) a peak at a 2θ in the range of 31-34°. The bimetallic catalyst may be alternatively or additionally characterized by having an XRD spectrum lacking (not having, being free of) a peak at a 2θ below 40°.

In some embodiments, the bimetallic catalyst is characterized by having an X-ray diffraction (XRD) pattern comprising at least one of the following reflections 2θ: 43° (111), 50° (200), 74° (220) and 90° (311). In some embodiments, the bimetallic catalyst is characterized by having an X-ray diffraction (XRD) pattern comprising at least one of the following reflections 2θ: 43° (111), 47° (200), 70° (220) and 84° (311).

In some embodiments, the bimetallic catalyst is characterized by having an X-ray diffraction (XRD) pattern comprising at least one of the following reflections 2θ: 41° (111), 45° (200), 69° (220) and 87° (311).

In some embodiments, the bimetallic catalyst is characterized by having an X-ray diffraction (XRD) pattern comprising reflections 2θ: a peak between 40 and 42° (111), a peak between 46 and 48° (200), a peak between 67 and 70° (220) and a peak between 83 and 85° (311).

In some embodiments, the bimetallic catalyst is characterized by having an X-ray diffraction (XRD) pattern of any one FIGS. 1A-1D.

As an exemplary comparative system, unlike the catalyst of [6], the catalyst of the invention presents a first peak at about 41° (between 40 and 42°, see FIGS. 1A-1D). The XRD does not contain any peaks below about 41°. Reference [6] teaches two points of importance, which may be used to distinguish the bimetallic catalyst of the invention and directly attest to its uniqueness:

(1) the catalyst of the invention has a crystallographic structure that is different from L1₂, the structure being identifiable by an XRD peak in the range of 31 to 34° (as indicated in paragraph [0044] of [6]), the bimetallic catalyst of the invention having a structure that is identified by L1₀; and

(2) the catalyst of the invention having an L1₀ structure is a stable catalyst (see of [6]).

The catalyst of [6] has L1₂ structure, while the catalyst of the invention is clearly not of an L1₂ structure. It is clear that for [6] to achieve a catalyst wherein, as defined in [6]: (i) the alloy particles have an L1₂ structure as an internal structure and has an extent of ordering of L1₂ structure in the range of 30 to 100 percent, (ii) the alloy particles have an LP ratio calculated by CO stripping method of 10 percent or more, and (iii) the alloy particles have a dN/dA ratio in the range of 0.4 to 1.0, the catalyst must be thermally treated at a high temperature (see paragraphs [0122]-[0133]). Under such high temperatures, annealing takes place which imposes a structural change or transformation from a disordered L1₀ structure to an ordered phase L1₂ structure.

The bimetallic catalyst of the invention is produced, as exemplified, at relatively low temperatures being between room temperature (25-32° C.) and 300° C., while the catalyst of the art, e.g., [6], was produced by treating the final material at temperatures higher than 300° C., typically exceeding 400 or 600° C. As stated in the art, under such temperatures, the structure of the catalyst particles changes to the L1₂ structure.

In some embodiments, the temperature used in the preparation of a bimetallic catalyst according to the invention is between 100 and 300° C. In other embodiments, the temperature is between 150 and 300° C. In some embodiments, the temperature is between 150 and 200° C. In some embodiments, the temperature is between 150 and 180° C., or between 160 and 180° C., or between 170 and 180° C., or between 160 and 190° C., or between 170 and 190° C., or between 180 and 190° C., or between 180 and 200° C.

In other embodiments, the temperature is about 180° C.

In some embodiments, the bimetallic catalyst further comprises at least one non-metal (e.g., as a solid support material). The non-metal may be used as a carrier material or as a support material. The at least one non-metal may be a carbonaceous material. Some non-limiting examples of a carbonaceous material include porous carbon, active carbon, carbon fiber, graphite fiber, carbon nanotube, carbon allotropes of various forms and molecular weights, etc.

Alternatively or additionally, the at least one non-metal may be selected amongst conductive polymers. Some non-limiting examples of the conductive polymers that may be used include polyvinyl carbazole, polyaniline, polypyrrole or derivatives thereof. Alternatively or additionally, the carrier or support material may be a metal-based material, such as metal oxides. Some non-limiting examples of the metal oxides include at least one metal oxide selected from the group consisting of oxides of tungsten, titanium, nickel, ruthenium, tantalum and cobalt.

The bimetallic catalyst of the invention may thus be provided supported on a non-metal, or conductive or any other known solid support or carrier, as known to one skilled in the art. The carrier is selected to disperse the bimetallic catalyst widely on its surface, to improve physical properties including thermal and mechanical stability. To provide a supported catalyst, it is possible to use any process known in the art for coating catalyst particles on a solid support. In some embodiments, the catalyst, e.g., PtCu, is supported on a carbon carrier, e.g., the carbon carrier being in an amount of between 45-10 wt %, at times between 5-9 wt %, further at times between 5-8 wt %.

The bimetallic catalyst disclosed herein can be prepared by any method known in the art. In accordance with some embodiments of the present invention, the bimetallic catalyst of the present invention is prepared by contacting a transition metal precursor with a platinum precursor in a solvent to obtain a mixture, followed by heating said mixture at a temperature above room temperature, e.g., about 180° C., for a period of time necessary to afford the catalyst. The bimetallic catalyst may thereafter be collected by standard collecting methods known in the art, such as by precipitation. As noted hereinabove, the temperature is selected not to cause transformation of the catalyst into the L1₂ structure. Thus, the invention further provides a process for the preparation of a bimetallic catalyst of the form PtM, wherein M is a metal selected as above, the process comprising:
contacting a transition metal (M) precursor with a platinum precursor in a liquid carrier to obtain a mixture, and
treating said mixture under conditions permitting formation of a PtM alloy, e.g., under heating at a temperature above room temperature, e.g., about 180° C., for a period of time necessary to afford the catalyst.

The process may further comprise a step of providing a solution of at least one transition metal precursor.

The process may further comprise a step of providing a solution of at least one platinum precursor.

In some embodiments, the conditions permitting formation of the alloy include thermal treatment at a temperature not exceeding 300° C., and being in some embodiments around 180° C., as further disclosed herein, and for a period of time sufficient to achieve full or substantially or ideal conversation of the metal precursors to the alloy.

The process may further comprise a step of separating the bimetallic catalyst.

The process may further comprise a step of contacting the PtM alloy, in a carrier or neat, or purified or separated from its carrier, with a solid non-metal support.

The process may be carried out in the presence of a solid non-metal support.

The transition metal precursor may be in the form of a salt or complex of the transition metal. Some non-limiting examples of transition salts or complexes that may be used as the transition metal precursor are hydrated salts or complexes of the transition metal.

In some embodiments, the transition metal precursor is a copper salt or complex. In such embodiments, the copper salt or complex is selected from copper chloride, copper sulfate, copper nitride and mixtures thereof. In some embodiments, the copper metal salt or complex comprises copper chloride, copper chloride dihydrate, copper nitride, divalent copper salts and complexes.

The platinum precursor is in the form of a salt or complex of platinum. In some embodiments, the platinum precursor salt or complex comprises platinum chloride, chloroplatinic acid hexahydrate, and/or chloroplatinic acid hexahydrate.

The liquid carrier, e.g., solvent used for preparing the transition metal and platinum precursor mixture is any type of a solvent capable of dissolving the metal precursors, e.g., salts. In some embodiments, the solvent used for preparing the precursor mixture is selected from ethylene glycol, water, ethanol, isopropanol, acetone and mixtures thereof.

The transition metal and platinum precursor mixture may be prepared in the presence of a polymer or a copolymer. The polymer or copolymer may be any type of a polymer or a copolymer capable of controlling the bimetallic catalyst composition obtained. In some embodiments, the copolymer used for preparing the precursor mixture is selected from poly(ethylene oxide), poly(propylene oxide), and combinations thereof.

As noted herein, the bimetallic catalyst of the invention is suitable and selected for use in a DDMEF cell. In the context of the present invention, a direct dimethyl ether fuel cell (“DDMEFC”) refers to a single fuel cell comprising at least one anode that comprises a catalytic layer loaded with the bimetallic catalyst of the present invention supported on a conductive carrier, at least one cathode and a membrane (preferably a proton conducting membrane) disposed therebetween, and configured to directly oxidize a fuel comprising a mixture of dimethyl ether and water. The bimetallic catalyst may be loaded on an anode of a DDMEFC or directly on the membrane, or directly on the gas diffusion layer or both. The bimetallic catalyst may further comprise any one additive selected from conductive agents, such as carbon particles, carbon nanotubes, graphene, graphene oxide, reduced graphene oxide, metal oxides, ceramics, non-metals; binders, such as polyvinylidene fluoride (PVDF), Nafion®, propylene carbonate, carboxymethyl cellulose (CMC), silver paste, styrene-butadiene rubber (SBR), polytetrafluoroethylene (PTFE), poly(ethylene oxide); and/or polytetrafluoroethylene (PTFE).

As detailed above, in the operation of a DDMEFC cell of the invention, a fuel stream comprising DME and humidified water is supplied to the anode chamber, and air or oxygen is supplied to the cathode chamber, wherein the anode chamber contains an anode that comprises a catalytic layer comprising a bimetallic catalyst of the present invention supported on a conductive carrier. At the anode chamber of the DDMEFC, oxidation of dimethyl ether occurs, and protons and electrons produced by the oxidation are transferred to the cathode chamber.

Thus, in another of its aspects, the present invention provides an anode for use in a direct dimethyl ether fuel cell, the anode comprising a catalytic layer comprising a bimetallic catalyst of the invention. In some embodiments, the catalyst is supported on a conductive carrier. Some non-limiting examples of a conductive carrier include carbonaceous material, conductive polymers or metal oxides, each as defined herein. In the case of a supported catalyst, the carrier may be in an amount of between 4-10 wt %, at times between 5-9 wt %, further at times between 5-8 wt %.

As noted above, the bimetallic catalyst may be loaded on an anode of a DDMEFC or directly on the membrane.

As known in the art, gas diffusion electrode is a support layer for supplying reactants and a catalyst layer, where the reactants are subjected to redox reactions (such cathode and anode are commonly referred to as gas diffusion electrodes).

Typically, an electrode for fuel cells comprises a gas diffusion layer and catalyst layer. It may comprise a catalyst layer alone. In other embodiments, it can have a catalyst layer integrally formed on a gas diffusion layer. Generally, the gas diffusion layer may be obtained by impregnating carbon paper or carbon fiber fabric having a conductivity and porosity of 80 percent or more with a hydrophobic polymer (for example, PTFE) and baking the resultant product at a high temperature.

An electrode for DDMEFC according to the present invention can be manufactured by a conventional method known to one skilled in the art. For example, catalyst ink is provided that contains the bimetallic catalyst of the present invention, a proton conductive material such as Nafion® and a mixed solvent enhancing dispersion of the catalyst. Then, the catalyst ink is applied on a gas diffusion layer by printing, spraying, rolling or brushing and dried to form the catalyst layer of the finished electrode.

According to yet another aspect, the present invention provides a membrane electrode assembly (MEA) for use in a direct dimethyl ether fuel cell, the MEA comprising an anode, a cathode and a membrane disposed between said anode and cathode; said cathode comprising a support and a catalytic layer optionally dispersed thereon; said anode comprising a bimetallic catalyst.

A membrane electrode assembly (“MEA”) refers to an assembly of electrodes, i.e., anode and cathode, for carrying out an electrochemical catalytic reaction between fuel and air/oxygen, and a polymer membrane. The membrane electrode assembly is a single unit having catalyst-containing electrodes adhered to an electrolyte membrane. In the membrane electrode assembly, each of the catalyst layers of the anode and cathode is in contact with the electrolyte membrane. The anode is loaded with the bimetallic catalyst of the present invention, and the cathode is optionally loaded with an oxygen reduction catalyst. The MEA can be manufactured by any conventional method known to one skilled in the art. For example, the electrolyte membrane is disposed between the anode and cathode to form an assembly. Next, the assembly is inserted into the gap between two hot plates operated in a hydraulic manner while maintaining a temperature in the range of 60-110° C., and then pressurized to perform hot pressing. The electrolyte membrane can be any material having proton conductivity, mechanical strength sufficient to permit film formation and high electrochemical stability. Some non-limiting examples of the electrolyte membrane include Nafion®, polybenzimidazole (PBI) and others. The fuel cell is assembled by using the above membrane electrode assembly and a bipolar plate in a conventional manner known to one skilled in the art.

In some embodiments, the MEA comprises an anode comprising a catalytic layer comprising the bimetallic catalyst of the invention, said catalyst being supported on a carrier, e.g., a conductive carrier.

In other embodiments, the MEA comprises a membrane, wherein the membrane is a proton conducting membrane.

According to yet another aspect of the present invention, there is provided a fuel cell comprising the above membrane electrode assembly. The fuel cell may be manufactured by using the above membrane electrode assembly and a bipolar plate in a conventional manner known to one skilled in the art. When operating a dimethyl ether fuel cell system that comprises one or more electrically connecting single cells, the fuel contains a mixture of dimethyl ether gas and humidified water which flows under pressure, and which includes one or more gas inlets, gas outlets, gas manifolds, gas flow controllers, flow field plates, back pressure valves electrically insulating frames and interconnector plates.

In another of its aspects, the invention provides a fuel formulation comprising water and dimethyl ether at a relative humidity (“RH”) between 0-100% RH for use in a dimethyl ether fuel cell.

The fuel formulation is fed to the anode by introducing a mixture of DME gas and humidified water, wherein said introducing is carried out by bubbling DME through humidity vessels.

The fuel according to the present invention may further comprise an acid, an additional organic fuel, a salt, a gas or any mixture thereof.

In some embodiments, the fuel formulation further comprises an organic fuel that is capable of reducing the fuel crossover. For example, by incorporating a fuel having a suitably large molecular size, namely, so that the fuel cannot pass through the electrolyte membrane (having a suitably small diffusion coefficient), the fuel crossover is reduced. Some non-limiting examples for such organic fuels are: methanol, diethyl ether, methylformat, ethylformat, dimethoxymethane, trimethoxymethane and trioxane.

In yet a further aspect, the present invention provides a fuel cartridge comprising the fuel formulation disclosed herein.

In still a further aspect, there is also provided a device adapted for holding a cartridge comprising the fuel formulation disclosed herein.

In another aspect, the present invention provides a direct dimethyl ether fuel cell comprising:
an anode comprising a conductive support and a catalyst layer dispersed thereon,
a cathode comprising a conductive support and optionally a catalyst layer dispersed thereon, and
a proton conducting membrane disposed between said anode and said cathode;

wherein said anode catalyst layer comprising a bimetallic catalyst, the bimetallic catalyst comprising/consisting: (i) platinum; and (ii) a transition metal selected from copper, nickel, cobalt, manganese, chromium and titanium; said bimetallic catalyst having a molar ratio of 1:4 to 2:1 between the platinum and the transition metal; and

wherein said anode is configured to directly oxidize fuel comprising a mixture of dimethyl ether and water.

The fuel cell can be manufactured by using the above membrane electrode assembly and a bipolar plate in a conventional manner known to one skilled in the art.

As detailed above, in the operation of the DDMEFC of the present invention, i.e., a fuel stream comprising DME and humidified water is supplied to the anode chamber, and air or oxygen is supplied to the cathode chamber, wherein the anode chamber comprises an anode that comprises a catalytic layer comprising the bimetallic catalyst of the present invention supported on a conductive carrier.

Protons released from DME oxidation are transferred to the cathode to react with molecular oxygen, O₂, which is reduced by the electrons that generate electrical energy. In such operation, said fuel stream (i.e., DME and water) is converted to CO₂ at a high conversion rate. As known to those versed in the art, the conversion rate of DME to CO₂ is dependent on the operating parameters of the DME fuel cell, specifically, temperature and voltage. Namely, the conversion rate deteriorates at a voltage below 0.55V and at a temperature below 100° C., due to fuel poisoning of the catalyst, for example due to CO impurities.

Some further non-limiting operating parameters are fuel flow rate, fuel concentration, anode back pressure, fuel cell components, i.e., membrane type and thickness, catalytic layer thickness, GDL type and thickness, relative humidity. etc.

In some embodiments, the fuel cell is operable at a temperature of between 60 and 110° C., at times operable between 70 and 110° C., at times between 80 and 110° C., at times between 90 and 110° C., at times between 100 and 110° C.

In some embodiments, the fuel cell is operable at a temperature of at most 110° C., at times at most 105° C., at times at most 100° C., at times at most 95° C., at times at most 90° C., at times at most 85° C., at times at most 80° C., at times at most 75° C., at times at most 70° C., at times at most 65° C.

In some embodiments, the fuel cell is operable at a temperature of 90° C.

In some embodiments the fuel cell having a conversion rate of DME to CO₂ of above 70% at a temperature between 70° C. to 110° C., as determined in accordance with the following equation:

$$\frac{1 / 2 \times {CO}_{2} producing rate}{DME supply rate} \times 100 \% ,$$

wherein the CO₂ reaction product rate and the DME reactant rate is evaluated by gas chromatography.

In other embodiments, the fuel cell conversion rate is determined at a temperature between 80° C. to 110° C., at times between 90° C. to 110° C., at times between 90° C. to 100° C., and further at times at 90° C.

In some embodiments, the fuel cell having an output power density determined at DME fuel cell operation temperature between 70° C. to 110° C. of at least 12 mW/cm² at a current density of 100 mA/cm².

In other embodiments, the fuel cell output power density is determined at a temperature between 80° C. to 110° C., at times between 90° C. to 110° C., at times between 90° C. to 100° C., and further at times at 90° C.

Application of a DDMEFC of the present invention in not particularly limited. The DDMEFC may be mounted on a vehicle, namely, may be applied as an add-on component to a vehicle, or may be applied as a full component of a vehicle.

Thus, another aspect of the present invention provides a DDMEFC for use in an electronic device, specifically, a portable electronic device or a stationary electronic device.

In some embodiments, the electronic device is selected from a drone, personal computer (such as laptop or tablet PC), portable phone, digital camera, household device, electric bicycles, toys, portable game machines, video camcorder and any portable electronic device; backup power, main power.

In such embodiments, the electronic device is a drone.

The DDMEFC of the present invention can be used alone or in combination with an additional power source, which supplies power when required. For example, for some applications such as to power a portable device, such as a cellular phone, it is advantageous to combine at least one DDMEFC with a high power rechargeable battery, DC to DC converter and a small high power lithium cell.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1D provide XRD patterns of Pt:Cu (1:1 molar ratio) metallic catalyst having Pt-to-Cu molar ratio of: (FIG. 1A) 1:1 in accordance with Example 1 of the invention, (FIG. 1B) 4:3 in accordance with Example 2 of the invention, (FIG. 1C) 2:1 in accordance with Example 3 of the invention and (FIG. 1D) 3:2 in accordance with Example 4 of the invention.

FIGS. 2A-2C provide SEM images of (FIG. 2A) particles of the Pt:Cu (1:1 molar ratio) bimetallic catalyst alloy, (FIG. 2B) mapping of copper particles, and (FIG. 2C) mapping of platinum particles; according to Example 1 of the present invention.

FIGS. 3A-3E provide HR-TEM images of (FIG. 3A) particles of the Pt:Cu (1:1 molar ratio) bimetallic catalyst alloy, (FIG. 3B) mapping of platinum particles, and (FIG. 3C) mapping of copper particles, (FIG. 3D) magnification of (FIG. 3A), and (FIG. 3E) EDX graph confirming that the alloy is platinum:copper 1:1; according to Example 1 of the present invention.

FIG. 4 provide different HR-TEM images of particles of the Pt:Cu (2:1 molar ratio) bimetallic catalyst alloy according to Example 3 of the present invention at different regions of the sample and magnifications.

FIGS. 5A-5B provide electrochemical activity tests (FIG. 5A) of Pt:Cu (1:1) bimetallic catalyst according to Example 1 of the invention and comparison with the Reference Samples Pt and Pt:Ru (1:1), and (FIG. 5B) different ratios of Pt-to-Cu in accordance with FIGS. 1A-1D.

FIGS. 6A-6B provide fuel cell test station (Scribner associates inc.), in which the catalyst was loaded onto the anode of a Nafion™ membrane (N-117). The cathode was loaded with carbon black supported platinum 20% (E-TEK), and reported as whole cell voltage.

### DETAILED DESCRIPTION OF EMBODIMENTS

The inventors of the technology disclosed herein have found that in a bimetallic catalyst comprising platinum and a transition metal of the kind described herein, platinum is oxidized to produce carbon dioxide, while carbon monoxide is removed from the active site of the platinum, resulting in a bimetallic catalyst that is tolerant of carbon monoxide poisoning, thereby maintaining a high activity for dimethyl ether oxidation. When the two elements in the bimetallic catalyst (i.e., platinum and a transition metal as described herein) having a defined structure, a defined molar ratio, a specific surface area, and/or a specific particle size are mixed at atomic level, an unexpectedly higher activity for DOR is exhibited. For example, when the atomic components of a bimetallic catalyst of the present invention comprising platinum and a transition metal are mixed to provide an alloy, the catalyst exhibits high activity for DOR. Thus, in some embodiments, the bimetallic catalyst disclosed herein, is an alloy.

### Experimental Techniques

Structure and morphology were acquired using scanning electron microscopy (SEM, FEI Quanta FEG 250, operating at 30 kV, secondary electrons operating mode, working distance 10 mm).

The atomic structure and morphology of a catalyst particle were acquired using high-resolution transmission electron microscopy (HR-TEM, JEOL-JEM-2100, (operating at 200 kV, LaB₆ filament, bright field).

XRD measurements were recorded with D8 Advance diffractometer using Cu Kα1 radiation. Full profile fitting of the collected data was performed using Diffrac. EVA software (Bruker AXS, Karlsruhe, Germany).

For compositional analysis, energy dispersive X-ray spectroscopy (EDX) measurements were performed, using Thermo-Fischer Ultra-dry silicon detector (TEM).

### Materials and Methods of Preparation

### Bimetallic Catalysts Synthesis

### Example 1—Obtaining Platinum-Copper (1:1) Alloy Catalyst

Platinum-Copper alloy was synthesized in the following method: 0.15 mmol of H₂PtCl₆.6H₂O and 0.15 mmol of CuCl₂.2H₂O were dissolved in a mixture solvent containing 20 ml of water and 40 ml of ethylene glycol. Subsequently, 0.001 mmol of Pluronic F127 was added to the solution, which was stirred for 60 min to obtain a clear solution. The solution was then transferred to a 100 ml Teflon-lined stainless autoclave. The autoclave was heated to 180° C. and kept at this temperature for 12 hours before it was cooled to room temperature. The products were Buchner vacuumed and washed with ethanol-water mixture for several times. The products were collected for characterization and catalyst tests.

### Characterization of the Bimetallic Catalyst of Example 1

### Structure and Morphology

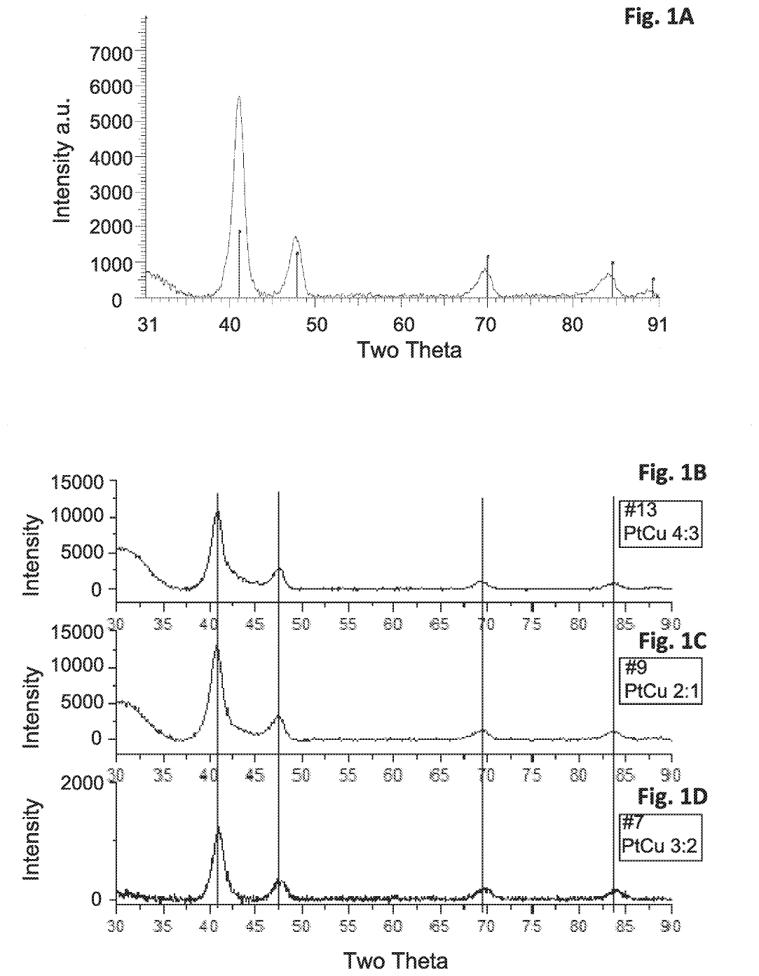

The XRD data displayed in FIG. 1A indicates that the bimetallic catalyst of Example 1 is a Pt—Cu alloy with a ratio of 1:1 and that the particle size is about 7 nm (nanocrystallite size calculated by applying “Scherrer Equation” on a XRD pattern).

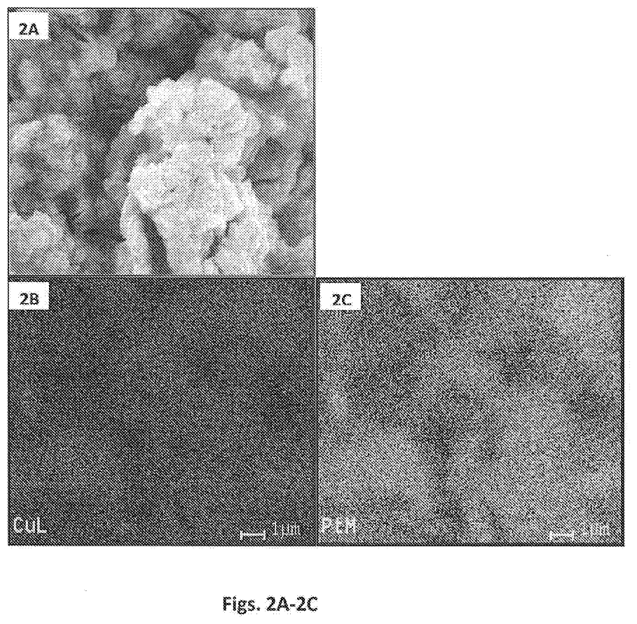

SEM imaging (FIG. 2A) and mapping (FIGS. 2B-2C) reveal that the product is an alloy rather than separated particles of platinum and copper. The mapping images in FIGS. 2B-2C show that the morphology in both copper (FIG. 2B) and platinum (FIG. 2C) has no significant areas which contain only one of these elements.

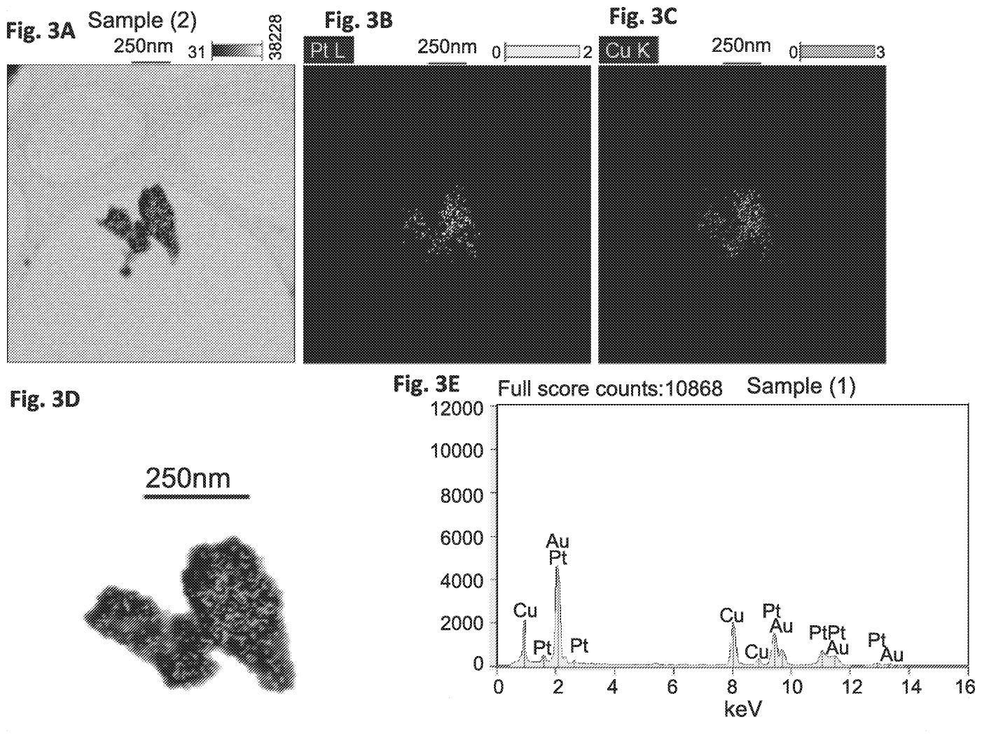

HR-TEM was used to image substantially smaller particles than the SEM and provides information down to nanometric resolution. In the HR-TEM images (FIGS. 3A-3C), a single particle of the bimetallic catalyst of Example 1 contains both elements, platinum (FIG. 3B) and copper (FIG. 3C). In addition, the EDX mapping image (FIG. 3D) and result table (FIG. 3E) confirms that the alloy has platinum:copper atomic ratio of 1:1. The gold presented in the EDX result originates from the HR-TEM grid.

TABLE 1
EDX results for the bimetallic catalyst of Example 1

| Element Line | Weight % | Weight % Error | Atom % |
|---|---|---|---|
| Cu K | 25.82 | +/−0.30 | 51.66 |
| Cu L | — | — | — |
| Pt L | 74.18 | +/−0.94 | 48.34 |
| Pt M | — | — | — |
| Au L | — | — | — |
| Au M | — | — | — |
| Total | 100.00 | | 100.00 |

All the above structure and morphology techniques performed on the bimetallic catalyst of Example 1 confirm that the platinum:copper alloy has an atomic ratio of 1:1. There is about 10% w/w of carbon in the product, which remains from the ethylene glycol used to reduce the precursors.

### Example 2—Obtaining Platinum-Copper (4:3) Alloy Catalyst

Platinum-Copper alloy was synthesized in the following method: 155 mg of 6H₂O.H₂PtCl₆, which are 0.3 mmol, were added to a 51 mg of 2H₂O.CuCl₂, which are also 0.3 mmol, in a biker. 25 mg of Pluronic F127 (0.002 mmol) were added to the mixture in a 20 ml H₂O: 40 ml Ethylene glycol solution and was stirred for 1 h. Then the solution was poured to an autoclave, which was heated for 14 h at 180° C. It was cooled down to room temp and filtered using a Buchner. Ethanol: H₂O mixture was added to the Buchner. The product was scraped with a spatula from the filtration paper.

### Characterization of the Bimetallic Catalyst of Example 2

### Structure and Morphology

The XRD data displayed in FIG. 1B indicates that the bimetallic catalyst of Example 2 is a Pt—Cu alloy with a ratio of 4:3 and that the particle size is 6.5 nm as calculated by “Scherrer Equation” (not shown here).

### Example 3—Obtaining Platinum-Copper (2:1) Alloy Catalyst

Platinum-Copper alloy was synthesized in the following method: Platinum-Copper alloy was synthesized in the following method: 0.3 mmol of H₂PtCl₆.6H₂O and 0.3 mmol of CuCl₂.2H₂O were dissolved in a mixture solvent containing 20 ml of water and 40 ml of ethylene glycol. Subsequently, 0.002 mmol of Pluronic F127 was added to the solution, which was stirred for 60 min to obtain a clear solution. The solution was then transferred to a 100 ml Teflon-lined stainless autoclave. The autoclave was heated to 180° C. and kept at this temperature for 12 hours before it was cooled to room temperature. The products were Buchner vacuumed and washed with ethanol-water mixture for several times. The products were collected for characterization and catalyst tests.

### Characterization of the Bimetallic Catalyst of Example 3

### Structure and Morphology

The XRD data displayed in FIG. 1C indicates that the bimetallic catalyst of Example 3 is a Pt—Cu alloy with a ratio of 2:1 and that the particle size is 7.3 nm as calculated by “Scherrer Equation” (not shown here).

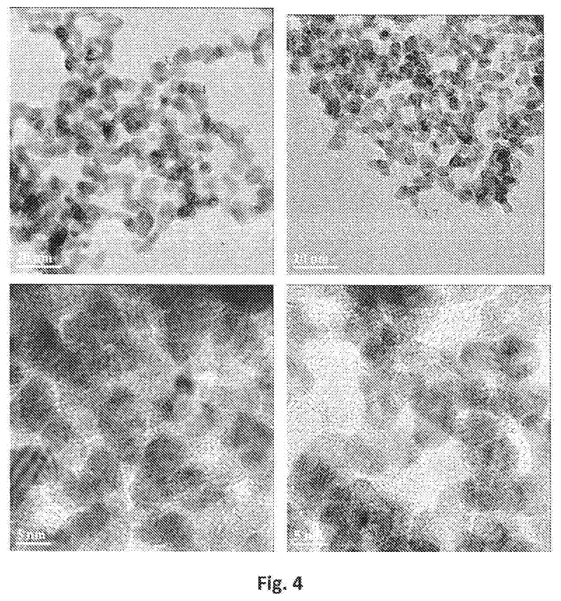

HR-TEM images displayed in FIGS. 4A-4D show that the bimetallic catalyst of Example 3 has Pt—Cu nanoparticles size of 3.2-3.9 nm.

### Example 4—Obtaining Platinum-Copper (3:2) Alloy Catalyst

Platinum-Copper alloy was synthesized in the following method:

77 mg of 6H₂O.H₂PtCl₆, which are 0.15 mmol, were added to a 25 mg of 2H₂O.CuCl₂, which are also 0.15 mmol, in a biker. 12.5 mg of Pluronic F127 (0.001 mmol) were added to the mixture in a 20 ml H₂O: 40 ml Ethylene glycol solution and was stirred for 1 h. Then the solution was poured to an autoclave, which was heated for 14 h at 180° C. It was cooled down to room temp and filtered using a Buchner. Ethanol: H₂O mixture was added to the Buchner. The product was scraped with a spatula from the filtration paper.

### Characterization of the Bimetallic Catalyst of Example 4

### Structure and Morphology

The XRD data displayed in FIG. 1D indicates that the bimetallic catalyst of Example 4 is a Pt—Cu alloy with a ratio of 3:2 and that the particle size is 6.7 nm as calculated by “Scherrer Equation” (not shown here).

### Electrochemical Characterization

a) Cyclic Voltammetry Measurements

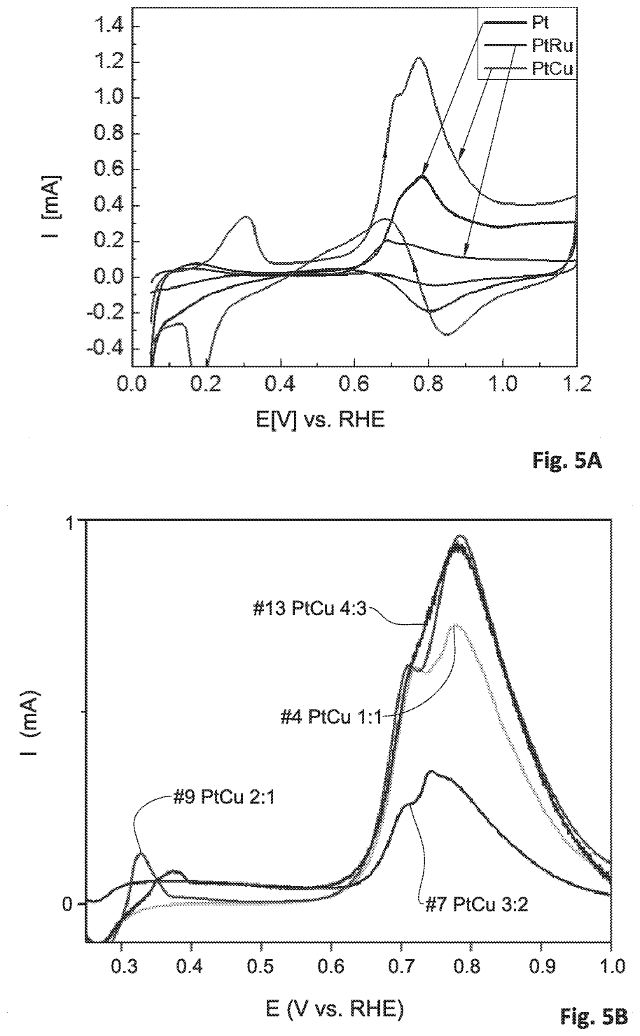

Electrochemical activity measurements were conducted in order to test the catalysis of DME electro-oxidation with the Pt—Cu alloy catalyst according to Example 1 of the present invention. Carbon black (Vulkan XC-72, E-TEK) supported Pt catalyst and Pt—Ru, catalyst (Aldrich, 20 w/w % and 10 w/w % respectively) were also tested as Reference Samples. The measurements were conducted in a half cell designed for gas diffusion electrode (Sigracet 25 BC GDL), allowing DME to flow and diffuse within the electrode surface, in 0.5M H₂SO₄. These results are reported in reference to a Real Hydrogen Electrode (RHE) and are displayed in FIG. 5A.

Further, electrochemical activity measurements were conducted in a half cell designed for gas diffusion electrode (Sigracet 25 BC GDL), allowing DME to flow and diffuse within the electrode surface in 0.5M H₂SO₄, for the Pt—Cu alloy catalyst according to Examples 1-4 of the present invention. These results are reported in reference to a Real Hydrogen Electrode (RHE) and are displayed in FIG. 5B. The results show that the DME oxidation with the Pt—Cu alloy catalyst of 4:3 and 2:1 ratios have the highest peak currents.

### Fuel Cell Tests

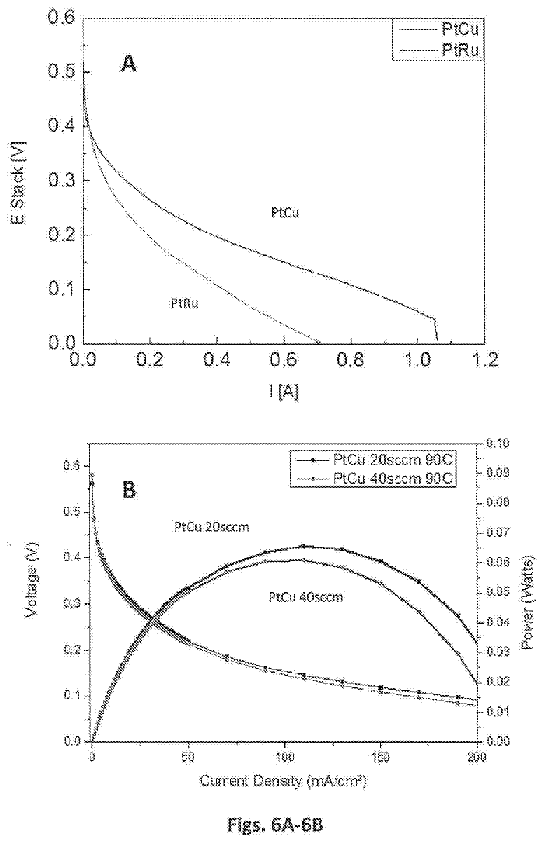

Fuel cell test station (Scribner associates inc. 850e), in which 10 mg/cm² catalyst according to Example 1 of the present invention was loaded onto the anode of a Nafion™ membrane (N-117). The cathode was loaded with carbon black supported platinum 20% (E-TEK). For comparison, a similar fuel cell using an anode loaded with a Pt—Ru catalyst (1:1) was also tested as a Reference Sample. Humidified DME was supplied to the anode at a flow rate of 20 and 40 sccm (standard cubic cm per minute, i.e., ml/min) and temperature of 80° C. and 90° C., then the current density was scanned and cell voltage and the power density of the fuel cells were measured. The results are reported as whole cell voltage and displayed in FIG. 6A. As displayed in FIG. 6A, the cell performance of the Pt—Cu catalyst of the present invention is noticeably improved in comparison to the Pt—Ru Reference catalyst.

Further, the effect of DME mass transfer on a direct DME fuel cell (“DDMEFC”) performance was tested as a function of flow rates of 20 and 40 sccm (standard cubic centimeters per minute) of humidified DME gas at 80° C. 90° C. using the catalyst (10 mg/cm² loading) according to Example 1 of the present invention loaded onto the anode of a Nafion™ membrane (N-117). The cathode was loaded with carbon black supported platinum 20% (E-TEK) and the results are displayed as whole cell voltage in FIG. 6B. A peak power of 0.44 Watt (namely, 0.088 W/cm² for a 5 cm² cell) was measured at a current density of 105 mA/cm². This indicates that the Pt—Cu alloy of the present invention has remarkable DME oxidation activity. In addition, the difference in performance at 20 and 40 sccm DME flow rates has small effect on the DDMEFC performance.

1.-41. (canceled)

42. A bimetallic catalyst alloy of the structure PtM, wherein Pt is platinum and M is a transition metal selected from copper, nickel, cobalt, manganese, chromium and titanium; the molar ratio of the platinum to the transition metal (Pt:M) is between about 1:4 to 2:1, the catalyst having an L1₀ structure; for use in oxidation of dimethyl ether in a direct dimethyl ether fuel cell.

43. The catalyst according to claim 42, wherein the molar ratio is between about 1:1 to 2:1, or the molar ratio is between 4:3 to 6:3, or the molar ratio is 3:2 or 3:3 or 4:3 or 6:3.

44. A bimetallic catalyst comprising:
(a) platinum; and
(b) a transition metal selected from copper, nickel, cobalt, manganese, chromium and titanium;
wherein the platinum is at a concentration of less than about 70 atomic percent, the catalyst having an L1₀ structure; for use in a direct dimethyl ether fuel cell.

45. The catalyst according to claim 42, having a structure different from L1₂.

46. The catalyst according to claim 42, having an XRD spectrum lacking a peak at a 2θ in the range of 31-34°, or having an XRD spectrum lacking a peak at a 2θ below 40°.

47. The catalyst according to claim 42, having an XRD pattern comprising one of the following patterns 2θ:
a. 43° (111), 50° (200), 74° (220) and 90° (311); or
b. 43° (111), 47° (200), 70° (220) and 84° (311); or
c. 41° (111), 45° (200), 69° (220) and 87° (311); or
d. a peak between 40 and 42° (111), a peak between 46 and 48° (200), a peak between 67 and 70° (220) and a peak between 83 and 85° (311); or
e. an X-ray diffraction (XRD) pattern of any one FIGS. 1A-1D.

48. The catalyst according to claim 42, supported on a solid support material, being optionally elected from the group consisting of a carbonaceous material, a conductive material and a metal oxide.

49. The catalyst according to claim 42, wherein M is copper such the catalyst alloy has the structure being PtCu.

50. A process for the preparation of a bimetallic catalyst alloy according to claim 42, the process comprising:
a. contacting a precursor of a transition metal M with a platinum precursor in a liquid medium to obtain a mixture,
b. heating said mixture at a temperature above room temperature and below 300° C., to afford the catalyst alloy;
c. optionally isolating said alloy; and
d. optionally contacting said isolated alloy or in solution with at least one solid carrier to afford a solid supported catalyst.

51. The process according to claim 50, wherein the temperature is selected not to cause transformation of the catalyst into the L1₂ structure.

52. A direct dimethyl ether fuel cell, DDMEFC, comprising at least one anode having a catalytic layer of a bimetallic catalyst according to claim 42.

53. A direct dimethyl ether fuel cell, DDMEFC, comprising at least one anode, at least one cathode and a membrane disposed therebetween, the membrane having a catalytic layer of a bimetallic catalyst according to claim 42.

54. An anode of a DDMEFC having a catalytic layer of a bimetallic catalyst according to claim 42.

55. An electrode for use in a fuel cell, the electrode comprising a catalyst layer comprising at least one bimetallic catalyst according to claim 42.

56. A membrane electrode assembly (MEA) for use in a direct dimethyl ether fuel cell, the MEA comprising an anode, a cathode and a membrane disposed therebetween; said anode comprising a bimetallic catalyst according to claim 42.

57. A fuel cell comprising an anode associated with a bimetallic catalyst according to claim 42.

58. A direct dimethyl ether fuel cell, comprising:
an anode comprising a conductive support and a catalyst layer dispersed thereon,
a cathode comprising a conductive support and optionally a catalyst layer dispersed thereon, and
a proton conducting membrane disposed between said anode and said cathode;
wherein said anode catalyst layer comprising a bimetallic catalyst alloy of the structure PtM, consisting: (i) platinum (Pt); and (ii) a transition metal M selected from copper, nickel, cobalt, manganese, chromium and titanium; said bimetallic catalyst having a Pt:M molar ratio of 1:4 to 2:1,
the alloy having L1₀ structure; and
wherein said anode is configured to directly oxidize fuel comprising a mixture of dimethyl ether and water.

59. The DDMEFC according to claim 58, for use in an electronic device, selected from a portable electronic device and a stationary electronic device.

60. The DDMEFC according to claim 59, wherein the electronic device is selected from a drone, a personal computer, a portable phone, a digital camera, a household device, an electric bicycles, a toy, a portable game machine, a video camcorder and a backup power device.

61. The DDMEFC according to claim 60, wherein the electronic device is a drone.
